(19) United States
(12) Patent Application Publication
(10) Pub. No.: US 2008/0128473 A1
(43) Pub. Date: Jun. 5, 2008

(54) Versatile Friction Stir Welding

(76) Inventors: Weijia Zhou, Madison, WI (US); Guillermo M. Tellez, Madison, WI (US); Nicholas S. Schmitt, Monona, WI (US)

Correspondence Address: Intellectual Property Dept./Dewitt Ross & Stevens;Wisconsin Alumni Research Foundation, 2 East Mifflin Street,, Suite #600, Madison, WI, 53703-2865, US

(21) Appl. No.: 11/564,873

(22) Filed: Nov. 30, 2006

(51) Int. Cl. B23K 20/12

(52) U.S. Cl. 228/2.3

(57) ABSTRACT

A friction stir welder includes a clamp mounted about the head from which the welding pin protrudes, with the head being extendable into and retractable from the clamp to insert and remove the welding pin from the area between the clamp halves (wherein a workpiece to be welded may be fit). The interiors of the clamp halves include rollers for engaging the workpiece, with at least one of the rollers being driven to feed the workpiece between the clamp halves and thereby move the workpiece with respect to the welding pin. Thus, the clamp halves may be closed about a workpiece, the welding pin can be driven into the clamped workpiece, and the workpiece can then be fed through the clamp halves to move the welding pin about the workpiece.

### FIELD OF THE INVENTION

This document concerns an invention relating generally to welding devices and processes, and more specifically to friction stir welding devices and processes.

### BACKGROUND OF THE INVENTION

Friction stir welding, a welding process introduced in U.S. Pat. No. 5,460,317, is an innovative welding process wherein a rotating pin is inserted into and/or between two items to be welded (usually metal items), and the pin is then rotated and driven along a path to join the items along the path. The pin contacts the items, frictionally plasticizes them, and stirs their material together, thereby joining the materials without fully melting them (as in more conventional welding methods). As a result, friction stir welding has several advantages over many conventional welding processes: since melting is avoided or minimized, related problems such as loss of temper characteristics, porosity, and shrinkage (with resulting distortion and residual stress) are reduced or eliminated; items are joined using their own materials, rather than filler materials, so chemical and property variations along welds can be reduced; and items to be joined need not have mating surfaces along the proposed weld line (i.e., gaps between the materials are tolerated by the process), which can ease pre-welding manufacturing burdens.

However, friction stir welding has several disadvantages as well, one of the most significant being its lack of versatility. Since the rotating welding pin must move between and/or through the items to be joined and effectively “blend” their component materials, the items must be tightly held during welding, and considerable force is needed to plunge the welding pin into the workpiece and drive the welding pin and workpiece with respect to each other. As a result, the friction stir welding device must generally be (or must be driven by) a robot or other actuator of significant power and size, and a clamping bed or other bulky clamping arrangement is needed to hold the workpiece. This significantly limits the use of friction stir welding, which cannot readily be implemented at a desired location (e.g., about a bulky and irregularly-shaped workpiece, such as an aircraft fuselage); which cannot practically be remotely deployed (i.e., a welding pin cannot be located at the end of an elongated robotic arm or the like owing to resulting stress on the arm); and which cannot practically be used for microfabrication (e.g., as where a small weld line is desired on very thin-gage metals).

### SUMMARY OF THE INVENTION

The invention involves friction stir welding devices which are intended to at least partially address the foregoing problems, and provide enhanced versatility and ease of use. To give the reader a basic understanding of some of the advantageous features of the invention, following is a brief summary of preferred versions of the invention, which will be described with reference to the accompanying drawings. Since this is merely a summary, it should be understood that more details regarding the preferred versions may be found in the Detailed Description set forth elsewhere in this document. The claims set forth at the end of this document then define the various versions of the invention in which exclusive rights are secured.

In a preferred version of the invention exemplified by FIGS. 1-2, a friction stir welding device 100 includes a housing 102 which is sized and configured to travel about a workpiece 1000, e.g., when carried by a human operator or a robotic arm, and to perform friction stir welding operations on the workpiece 1000. The housing 102 includes a pair of clamps 104 and 106 fixed to travel with the housing 102, with the clamps 104 and 106 being actuatable to grasp the workpiece 1000 therebetween, and a rotatable welding pin 108 (FIG. 2) which is extendable from the housing 102 into an area between the clamps 104 and 106 (and which is also retractable from this area back to the housing 102). Thus, the welding pin 108 may plunge into and frictionally stir a workpiece 1000 fixed between the clamps 104 and 106. To allow the housing 102 and welding pin 108 to more easily move about the workpiece 1000 and weld along a desired path, each clamp 104/106 preferably bears at least one roller 110 (FIG. 2) which at least partially protrudes into the area between the clamps 104 and 106. At least one of the rollers 110 is drivable, whereby a workpiece 1000 situated between the rollers 110 may be driven to travel between the clamps 104 and 106 with respect to the housing 102 (i.e., welding along a desired path may be effected by driving the workpiece 1000 between the clamps 104 and 106 with the housing 102 being stationary, by moving the housing 102 about a stationary workpiece 1000, or by moving both the workpiece 1000 and housing 102). As a result, the force required to move the workpiece 1000 and welding pin 108 with respect to each other is substantially reduced, to the point that an operator may manually move the housing 102 and workpiece 1000 with respect to each other, and/or to the point that the housing 102 might (for example) be situated at the end of a robotic arm without generating undue stress in the arm when moving the housing 102 and workpiece 1000 with respect to each other. Preferably, each clamp 104/106 bears at least two rollers 110, with the rollers 110 being located on opposing sides of a plane along which the welding pin 108 extends from and retracts toward the housing 102 so that the workpiece 1000 is grasped and driven by the rollers 110 on opposing sides of the welding pin 108.

A preferred arrangement for the clamps 104 and 106 is best seen in FIG. 2, wherein a first clamp 104 is situated between the housing 102 and a second clamp 106, with the first clamp 104 being affixed to the housing 102 (preferably removably affixed, as by connectors 112) and including a clamp aperture 114 through which the welding pin 108 may extend. The second clamp 106 is then actuatable to travel toward the first clamp 104 and housing 102 (as by traveling on shafts or screws 116) to clamp a workpiece 1000 between the first and second clamps 104 and 106, and also away from the first clamp 104 and housing 102 to release the workpiece 1000. The second clamp 106 preferably travels along a linear path toward the first clamp 104, this path being oriented perpendicularly to the path of travel of the workpiece 1000 between the clamps 104 and 106, with the rollers 110 each translating along a respective fixed plane as the clamps 104 and 106 are opened and closed.

To achieve extension and retraction of the welding pin 108, the welding pin 108 preferably protrudes from and rotates with respect to a head 118 (here shown in FIG. 2 as the head of the drive motor 120 used to rotatably drive the welding pin 108), and the drive motor 120 and head 118 extend from and retract toward the housing 102 with the welding pin 108 by means of threading 122 (with the threading 122 orbiting an axis coincident with or at least substantially parallel to the axis of rotation of the welding pin 108). Thus, acting upon the threading 122 moves the drive motor 120 and extends and retracts the welding pin 108 with respect to the housing 102. The clamp aperture 114 defined in the first clamp 104 is sized to allow the head 118 to at least partially extend therein so that the welding pin 108 may extend into the area between the clamps 104 and 106.

It has been found useful, for sake of further relieving the force needed to move the housing 102 and the workpiece 1000 with respect to each other, to rotate the welding pin 108 at substantially higher speeds than those used in conventional friction stir welding: preferably at greater than 5000 rpm, and more preferably at 6000 rpm or more. Further, the welding pin 108 preferably bears threading 124 to enhance stirring/mixing of the plasticized metal of the workpiece 1000.

The device 100 is preferably self-reacting, that is, the clamps 104 and 106 and the workpiece 1000 (and the rollers 110 therebetween) form a closed loop along with the welding pin 108, such that the clamps 104/106 firmly grasp the workpiece and counteract the various forces needed to enable friction stir welding, e.g., the plunging force needed to urge the pin 108 within the workpiece 1000, the torques generated when the pin 108 is rotated with respect to the workpiece 1000, and the traverse forces encountered as the pin 108 travels along the workpiece 1000 to produce a welded seam. Thus, a user need not personally apply these forces: a user does not have to urge the housing 102 toward the workpiece 1000 to effect plunging of the welding pin 108, nor does a user have to restrain the device 100 to prevent it from twisting with respect to the workpiece 1000 as the pin 108 rotates, nor does a user have to push the device 100 about the workpiece 1000 to generate a seam. With respect to seam generation, the device is preferably self-propelled, such that the rollers 110 will drive the device 100 about the workpiece 1000, and/or feed the workpiece 1000 between the clamps 104 and 106 of the device 100, as directed by the operator of the device 100.

Since the device 100 supplies both workpiece clamping actions (via the clamps 104 and 106) and lateral pin-driving actions (via the roller(s) 110) which are localized about and traveling with the welding pin 108, the device 100 is more readily usable on workpieces 1000 which are not readily accommodated in conventional friction stir welding beds. For example, a user might manually move the device 100 as desired in multiple dimensions about some item being manufactured (e.g., aircraft/spacecraft hulls). This freedom of movement, coupled with the fact that friction stir welding is not restricted to welding of largely horizontal items (as in many conventional welding processes, wherein flowing of the melt pool is a concern), allows for highly versatile use of the device 100.

Further advantages, features, and objects of the invention will be apparent from the following detailed description of the invention in conjunction with the associated drawings.

### BRIEF DESCRIPTION OF THE DRAWINGS

FIG. 1 is a perspective view of an exemplary friction stir welding device 100 having clamps 104 and 106 which may engage a workpiece 1000 (here a pair of metal members 1000a and 1000b to be welded together), and wherein the device 100 may be directed by hand or by robotic operation along the workpiece 1000 to effect welding.

FIG. 2 is an exploded and quarter-sectioned view of the exemplary friction stir welding device 100 of FIG. 1, wherein the housing 102 of the device 100 is shown spaced from the clamps 104 and 106 (which are also shown spaced), showing the welding pin 108 used to effect welding, and also showing the rollers 110 which are used to feed the workpiece between the clamps 104 and 106 (with at least one of the rollers 110 being driven to effect such feeding).

### DETAILED DESCRIPTION OF PREFERRED VERSIONS OF THE INVENTION

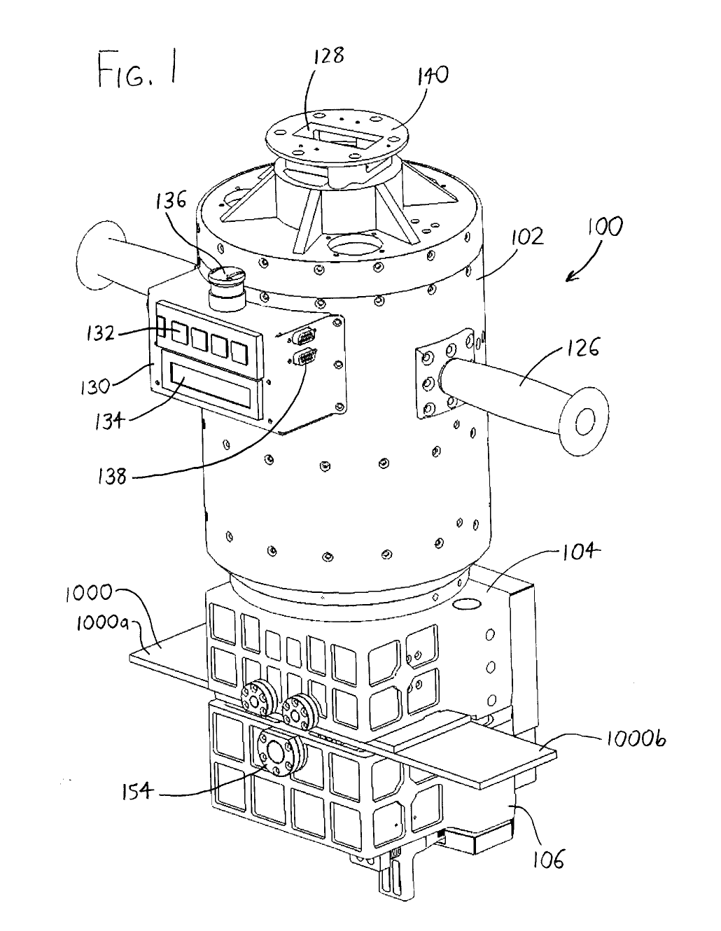

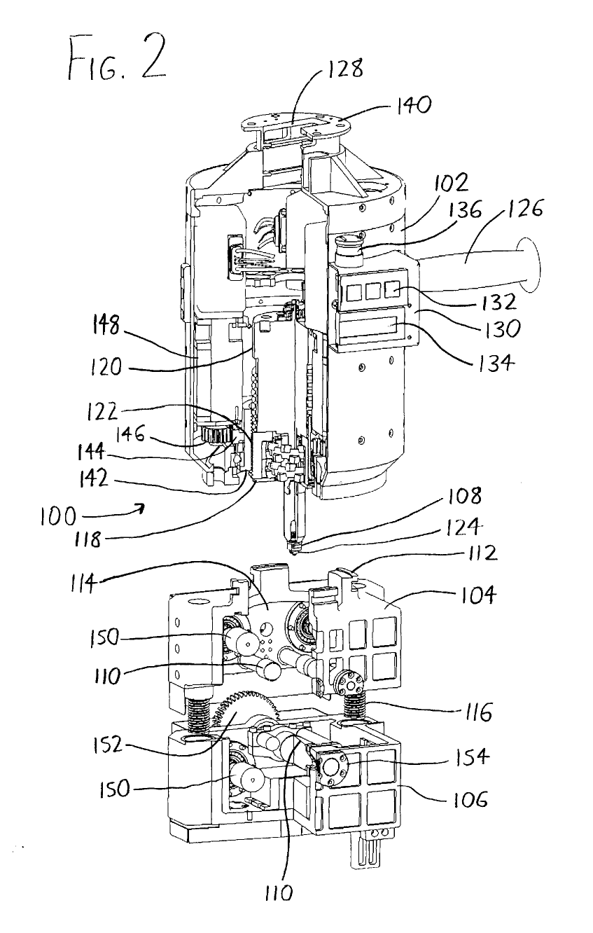

Expanding on the foregoing discussion, FIGS. 1 and 2 illustrate an exemplary hand-held (i.e., manually actuated) version of the invention at 100, wherein the clamps 104 and 106 might be affixed about a workpiece 1000, the welding pin 108 is then plunged into the workpiece 1000, and the rollers 110 then serve to drive the device 100 along the workpiece 1000, with a user grasping and directing the device 100 by use of the handles 126. A port 128 is depicted at the top of the device 100 for installation of power and/or communications cables. A control bank 130 with actuation buttons 132 and a display 134 is provided for purposes of manual control, with the buttons 132 allowing scrolling through, and selection of, commands depicted on the display 134. The control bank 130 is also depicted with an emergency stop button 136, and with input/output ports 138 (FIG. 1) which can serve as an alternative means of providing communications to and from the device 100 (and which might communicate control commands to the clamps 104/106, as discussed below). Where the device 100 is to be operated via a robotic manipulator rather than by hand, a flange 140 surrounding the port 128 can be used to mount the housing 102 to a robotic arm or the like, with control communications being communicated through port 128 (and/or ports 138).

Since it may at times be useful to utilize differently configured and dimensioned clamps 104 and 106 in the device 100 (to accommodate differently configured and dimensioned workpieces 1000), the housing 102 of the device 100 is preferably removably connectable to the clamps 104 and 106 so that different clamps 104 and 106 may be installed when desired. Thus, as best seen in FIG. 2, quick-release connectors 112 are preferably provided on the housing 102 and first clamp 104 (with the depicted connectors 112 being exemplary, and other types of connectors 112 being possible). These connectors 112 enable connection when the housing 102 and first clamp 104 are brought into close relationship (with the welding pin 108 inserted within the clamp aperture 114 of the first clamp 104), and the housing 102 and first clamp 104 are then rotated with respect to each other to bring their connectors 112 into engagement. Preferably, the direction of such engaging rotation is opposite the direction of rotation of the welding pin 108 so that the force of the welding pin 108 acting on a workpiece 1000 will not assist in disengagement of the housing 102 and first clamp 104. As noted above, the configuration of the connectors 112 depicted in FIG. 2 is merely exemplary, and a variety of other connectors may be used instead, e.g., the housing 102 and first clamp 104 could alternatively be simply bolted together.

The drive motor 120, which may be provided by Magmotor (Boston, Mass., USA) or another provider, has a generally cylindrical shape aligned along the axis of the welding pin 108, with the threading 122 being defined about at least a portion of the circumference of the drive motor 120. To urge the drive motor 120 into the clamp aperture 114 of the first clamp 104 (and situate the welding pin 108 in the area between the clamps 104 and 106), the threading 122 may be actuated by an internally-threaded collar 142 which is fixed to rotate in place about the drive motor 120, and which has a circumferentially-protruding toothed section 144. This toothed section 144 is driven by one or more gears 146 spaced about and engaging the circumference of the toothed section 144 of the collar 142, with each of the gears 146 being driven by a plunging motor 148 (which may be provided by Animatics, Santa Clara, Calif., or another provider). Thus, actuation of the plunging motor(s) 148 drives the connected gears 146, which in turn rotates the collar 142 via its toothed section 144, with the collar 142 moving the drive motor 120 (and thus the welding pin 108) toward and away from the clamps 104 and 106. At the same time, the drive motor 120 can be powered to rotate the welding pin 108, or depowered to slow or halt the pin 108. The drive motor 120 is powered via flexible wiring (not shown) which accommodates the extension and retraction of the drive motor 120.

The clamps 104 and 106 may be driven together or apart in the clamping direction by any suitable actuator, with screws 116 being depicted in FIG. 2 as a preferred means for effecting clamping. These screws 116 (or other clamping actuators) may be manually actuated, but are preferably driven by motors or other non-manual actuators (not shown in FIG. 2). Such motors/actuators may be powered and controlled by a plug-in cable extending from the housing 102, as from the ports 138.

The rollers 110 are driven by roller driving motors 150, which may be provided by Maxon (Fall River, Mass.), The roller driving motors 150 may also be powered/controlled by electrical connections to the housing 102, e.g., via a disconnectable cable leading to ports 138. For increased torque, appropriate gears (only one which is shown at 152) are interposed between the rollers 110 and the roller driving motors 150. Caps 154 maintain the rollers 110 and their supporting bearings in place on the clamps 104 and 106.

To again summarize the operation of the device 100, the device 100 may be grasped about its handles 126 by a user, or otherwise mounted to a robotic arm or other actuator via the flange 140 (or via other structure), and may be situated with a workpiece 1000 between its first and second clamps 104 and 106. The clamps 104 and 106 may then be closed via the clamping screws 116 or other clamping actuators so that the rollers 110 grasp the workpiece 1000, the welding pin 108 may be activated, and the drive motor 120 may be driven by the collar 142, gear 146, and motor 148 to plunge the welding pin 108 into the workpiece 1000. The rollers 110 may then be activated to laterally drive the welding pin 108 along a desired welding path on the workpiece 1000. The drive force exerted by the roller driving motors 150 may be adjusted to drive the rollers 110 (and thus drive the workpiece 1000 with respect to the device 100) at some desired speed, which might be controllable via the control bank 130.

As previously noted, the clamps 104 and 106, and the rollers 110 therein, allow a human or robotic operator to direct the device 100 along a workpiece 1000 without having to supply the forces needed to counterbalance the force/torque of friction stir welding. Without the use of the clamps 104/106 to grasp the workpiece 1000 as the welding pin 108 is plunged into the workpiece 1000, it would be exceedingly difficult (if not impossible) for a human operator to effect plunging of the welding pin 108. Similarly, while it may be possible to move the device 100 and the workpiece 1000 with respect to each other without positively driving the rollers 110, a human operator would rapidly become fatigued by to the extreme force needed to laterally drive the welding pin 108 through and about the workpiece 1000. The ability to use the device 100 without the need to supply significant external force to move it with respect to a workpiece 1000 allows the device 100 to be used in a far greater range of robotically-driven operations. For example, the device 100 may now be situated and used at the end of an elongated and articulated robotic arm, whereas in the past such an arrangement was effectively impossible (or at least exceedingly expensive) owing to the reinforcement required for such an arm, and the power needed to effectively manipulate the welding device.

An exemplary preferred version of the invention has been shown and described above to illustrate possible features of the invention, but it should be understood that the invention may adopt a variety of configurations which substantially vary from that of the exemplary version 100. Following is an exemplary list of modifications that might be made to the exemplary version 100.

First, as suggested above, the clamps 104 and 106 may adopt a wide variety of sizes and configurations depending on the workpiece 1000 which they are to grasp. The space defined between the closed clamps 104 and 106 need not be planar, and might be curved or convoluted for workpiece members 1000a and 1000b having more complex configurations. To further assist in clamping of larger workpieces 1000, the clamps 104 and 106 could also bear removable extensions with passive, freely-rotatable rollers, with these extensions being attachable and removable to the clamps 104 and 106 as needed.

Second, the number and configuration of the rollers 110 which engage the workpiece 1000 may be revised to alter their ability to grip certain workpieces 1000, and/or to alter the steerability of the device 100 about the workpiece 1000; for example, the surfaces of the rollers 110 may be made narrower (e.g., in the nature of wheels) or wider. As further examples, some or all of the rollers 110 may be covered by belts, may have knurled/roughened or elastomeric surfaces, or may otherwise be adapted to better engage or frictionally grasp the workpiece members 1000a and 1000b for feeding between the clamps 104 and 106. Independently driven rollers 110 might be situated at the opposing lateral sides of the device 100, and might be driven at different speeds when so instructed by the control bank 130 and/or other controls, whereby the device 100 might be steered along complex paths to form nonlinear seams. (In this respect, the device 100 is not manually steerable along nonlinear paths, at least without application of significant force, owing to the resistance offered by the workpiece 1000 to the welding pin 108. Thus, it will generally only be movable about a workpiece 1000 as driven by the rollers 110. Wide rollers 110 with synchronized speeds will tend to restrict the device 100 to straight-line welding paths, whereas narrower rollers 110 with independently adjustable speeds will allow greater steerability.)

Finally, it is emphasized that a wide variety of changes may be made to the configuration of the device. The housing 102 need not take the cylindrical form depicted in FIGS. 1-2; the clamps 104 and 106 need not be detachable from the housing 102; the clamps 104 and 106 may be differently configured (e.g., the first clamp 104 might be formed of a one-piece “C,” and the second clamp 106 might move within the first clamp 104 to effect clamping); and so forth.

The invention is not intended to be limited to the preferred versions of the invention described above, but rather is intended to be limited only by the claims set out below. Thus, the invention encompasses all different versions that fall literally or equivalently within the scope of these claims.

What is claimed is:

1. A friction stir welding device comprising:
a. a housing sized and configured to travel about a workpiece to perform welding operations thereon, the housing having a rotatable welding pin which is extendable from and retractable toward the housing;
b. a pair of clamps fixed to travel with the housing, wherein the welding pin is extendable into an area between the clamps.

2. The friction stir welding device of claim 1 wherein the pair of clamps includes first and second clamps, the first clamp being situated between the housing and the second clamp, wherein:
a. the housing is affixed to the first clamp, and
b. the first clamp has a clamp aperture defined therein, wherein the welding pin is extendable into the clamp aperture.

3. The friction stir welding device of claim 2 wherein:
a. the welding pin protrudes from and rotates with respect to a head,
b. the head extends from and retracts toward the housing with the pin; and
c. the clamp aperture is sized to allow the head to extend therein.

4. The friction stir welding device of claim 1 wherein:
a. the welding pin is rotatably driven by a drive motor;
b. the drive motor has threading affixed, the threading orbiting an axis coincident with or at least substantially parallel to the axis of rotation of the welding pin; and
whereby the welding pin is extendable from and retractable toward the housing by acting on the threading.

5. The friction stir welding device of claim 1 wherein the pair of clamps includes first and second clamps, the first clamp being situated between the housing and the second clamp, with the second clamp being actuatable:
a. toward the first clamp and housing to clamp a workpiece between the first and second clamps, and
b. away from the first clamp and housing to release the workpiece.

6. The friction stir welding device of claim 5 wherein:
a. the first and second clamps each bear at least one roller thereon which at least partially extends into the area between the clamps;
b. the second clamp is actuatable toward the first clamp with the rollers each translating along a respective fixed plane.

7. The friction stir welding device of claim 1 wherein the pair of clamps includes first and second clamps wherein:
a. each clamp bears at least one roller thereon which protrudes into the area between the clamps;
b. at least one of the rollers is drivable, whereby a workpiece situated between the rollers may be driven to travel between the clamps with respect to the housing.

8. The friction stir welding device of claim 7 wherein each clamp bears at least one drivable roller.

9. The friction stir welding device of claim 7 wherein each clamp bears at least two rollers, the rollers being located on opposing sides of a plane along which the welding pin extends from and retracts toward the housing.

10. The friction stir welding device of claim 1 wherein the welding pin bears threading.

11. The friction stir welding device of claim 1 wherein the welding pin rotates at greater than approximately 5000 rpm.

12. The friction stir welding device of claim 1 wherein the welding pin rotates at greater than approximately 6000 rpm.

13. A friction stir welding device comprising:
a. a housing sized and configured to travel about a workpiece to perform welding operations thereon;
b. first and second clamps fixed to travel with the housing, the first clamp being situated between the housing and the second clamp, with the second clamp being actuatable to travel:
(1) toward the first clamp and housing to clamp a workpiece between the first and second clamps, and
(2) away from the first clamp and housing to release the workpiece,
wherein the housing includes a rotatable welding pin extending toward the area between the first and second clamps.

14. The friction stir welding device of claim 13 wherein the welding pin rotates at greater than approximately 5000 rpm.

15. The friction stir welding device of claim 13 wherein the welding pin is extendable from and retractable toward the housing.

16. The friction stir welding device of claim 13 wherein:
a. the first and second clamps each bear at least one roller thereon which protrudes into the area between the clamps;
b. at least one of the rollers is drivable, whereby a workpiece situated between the rollers may be driven to travel between the clamps with respect to the housing.

17. A friction stir welding device comprising:
a. a housing bearing a rotatable welding pin, the housing being sized and configured to travel about a workpiece to perform welding operations thereon;
b. first and second clamps fixed to travel with the housing, wherein:
(1) each clamp bears at least one roller thereon which protrudes into the area between the clamps;
(2) at least one of the rollers is drivable, whereby a workpiece situated between the rollers may be driven to travel between the clamps with respect to the housing.

18. The friction stir welding device of claim 17 wherein the welding pin rotates at greater than approximately 5000 rpm.

19. The friction stir welding device of claim 17 wherein the welding pin is extendable from the housing into an area between the clamps, and is thereafter retractable toward the housing.

20. The friction stir welding device of claim 17 wherein the first clamp is situated between the housing and the second clamp, with the second clamp being actuatable:
a. toward the first clamp and housing to clamp a workpiece between the first and second clamps, and
b. away from the first clamp and housing to release the workpiece.
